(19) United States
(12) Patent Application Publication
(10) Pub. No.: US 2018/0312098 A1
(43) Pub. Date: Nov. 1, 2018

(54) ROLL-OFF FRAME HAVING FLOATING LOCKDOWN MECHANISM

(71) Applicant: Omaha Standard, LLC, Council Bluffs, IA (US)

(72) Inventors: Lazar MARMUR, Plainsboro, NJ (US); Kenneth E. BAILEY, JR., Vineland, NJ (US); Wayne Harry DAVIS, Lumberton, NJ (US)

(21) Appl. No.: 15/583,237

(22) Filed: May 1, 2017

(51) Int. Cl. B60P 1/64; B60P 7/13

(52) U.S. Cl. CPC B60P 1/6454; B60P 7/13

(57) ABSTRACT

An apparatus for loading and unloading containers of various lengths onto and off of a roll-off vehicle has a floating lockdown mechanism which moves relative to a front end of the top frame. The floating lockdown mechanism is movable away from the front end of the top frame to meet and releasably confine a front roller on a shorter container, such that the lockdown mechanism can be utilized without pulling the container all the way to the front end of the top frame.

### FIELD OF THE INVENTION

The present invention relates generally to roll-off transport vehicles equipped to load a large container, typically a waste container, onto the vehicle and to unload the container from the vehicle. More particularly, the present invention relates to a lockdown mechanism for securing a container on a tiltable frame of a roll-off vehicle for transport.

### BACKGROUND OF THE INVENTION

Roll-off vehicles are known to include a top frame mounted on the vehicle for supporting a container. The top frame is pivotally mounted to be tilted away from a horizontal home position such that the top frame is inclined toward a rear of the vehicle to assist in loading and unloading the container. The top frame may be tilted by one or more lift actuators, for example hydraulically powered linear actuators, arranged between the top frame and a subframe fixed to the vehicle. The top frame may incorporate a cable hoist mechanism having a set of sheaves and a cable wound around the sheaves. Some of the sheaves may be mounted on one or more movable shoe members that are displaceable along the top frame to take up an end of the cable coupled to the container to pull the container onto the top frame during loading. Sheave displacement may be reversed to unload the container. A lockdown mechanism may be provided at a fixed location at the front of the frame for engaging a front roller or grip bar of the container to secure the container on the frame during transport.

U.S. Pat. No. 8,029,228 to Marmur discloses a roll-off frame in which the cable hoist mechanism includes a single movable shoe member for displacing a multi-grooved sheave relative to a pair of sheaves mounted at a fixed forward location on the frame. A lockdown mechanism is provided at the front of the frame to secure front rollers or a lateral member of the container to hold the container in position on the frame. The lockdown mechanism includes a pair of laterally spaced front hook members on a top frame portion arranged to receive the front rollers or lateral grab bar of the container when the container is pulled fully forward onto the frame, and a pair of laterally spaced locking struts fixed to a subframe and positioned to block the hook openings when the top frame is pivoted down to a horizontal home position with respect to the subframe. The roll-off frame disclosed in U.S. Pat. No. 8,029,228 has a fixed length and is suited for supporting containers of a particular predetermined standard length. The lockdown mechanism is provided at a fixed location at the front of the frame.

U.S. Pat. No. 4,840,532 to Galbreath teaches a “universal” roll-off frame intended for use with containers of various lengths. The roll-off frame is characterized by a two-part top frame having a main portion and a forward head portion telescopically extendable and retractable relative to the main portion to adjust the overall length of the top frame. The roll-off frame of Galbreath incorporates a hydraulic actuator for adjusting the length of the top frame, and a cable hoist mechanism having a system of hydraulic actuators and sheaves for operating a cable attached to a container. Before using the roll-off frame of Galbreath, the operator must adjust the head portion relative to the main portion to achieve a desired overall length for a given container, and releasably fix the head portion in position to prevent further movement of the head portion relative to the main portion.

Galbreath describes a locking mechanism for securing the container on the top frame. The locking mechanism of Galbreath includes a pair of laterally spaced front hook members fixedly mounted at the front of the head portion of the top frame to receive the front rollers or grab bar of the container, and a pair of laterally spaced spring-loaded detents adjacent the hook members. The detents pivot downward against the spring bias as the container is pulled into its fully forward position, and pivot back up once the container is in place. The locking mechanism is stationary with respect to the head portion of the top frame.

The locking mechanisms described in U.S. Pat. No. 8,029,228 and in the patent to Galbreath require the operator to fully retract the cable hoist mechanism to bring the container all the way to the front of the frame for locking. However, if the roll-off vehicle is used to load and unload containers of different lengths, there is a risk that shorter containers may cause imbalanced loading on the lift actuators used to tilt the frame. More specifically, the center of gravity of the container load may be brought too far forward relative to the lift actuators, thereby causing the lift actuators to bind as they attempt to tilt the frame from horizontal. To address this problem, it is known to provide mechanical limit stops, sometimes referred to in the industry as “short stops,” which may be removably installed on an existing roll-off frame at a desired fixed position along the frame to prevent shorter containers from being pulled too far forward onto the frame. This solution, however, renders front-end locking mechanisms useless because the front of the container is spaced rearward from the locking mechanism. Because an installation step is involved and the limit stops must be removed when the roll-off frame will be used for a different length container, there is a tendency for operators to simply not use removable short stops.

### SUMMARY OF THE INVENTION

The invention provides an apparatus for loading and unloading containers of various lengths onto and off of a roll-off vehicle. The invention addresses shortcomings of the prior art mentioned above.

The apparatus generally comprises a top frame mounted on the vehicle to pivot about a transverse hinge axis relative to the vehicle, and at least one lift actuator operable to rearwardly incline the top frame relative to the vehicle by pivoting the top frame about the hinge axis away from a horizontal home position of the top frame. A cable hoist mechanism is associated with the top frame and includes a cable having a fixed end coupled to the top frame and a free end configured for coupling to a container. The apparatus is characterized by a lockdown mechanism coupled to the top frame for releasably confining a front roller or a grab bar of the container, wherein the lockdown mechanism is movable (i.e. “floats”) relative to a front end of the top frame along a longitudinal direction of the top frame. The lockdown mechanism is movable away from the front end of the top frame to meet a front roller on a shorter container, whereby the lockdown mechanism can be utilized without pulling the container all the way to the front end of the top frame.

The top frame may include a forward limit stop and a rearward limit stop, such that the lockdown mechanism is movable relative to the front end of the top frame between the forward limit stop and the rearward limit stop. The lockdown mechanism may be configured to slide automatically by gravity along the top frame toward the rearward limit stop as the top frame is tilted rearwardly away from the horizontal home position by the lift actuator(s).

In one embodiment of the invention, the lockdown mechanism includes a front hook member defining a rearwardly facing opening for receiving the front roller of the container, a sleeve fixed to the front hook member through which a longitudinal member of the top frame is slidably received, and a gate member movably connected to the front hook member. The gate member is movable relative to the front hook member between an open position wherein the gate member does not block the opening of the front hook member and a closed position wherein the hook member at least partially blocks the opening of the front hook member. When the top frame is rearwardly inclined away from the horizontal home position, the gate member drops down by gravity to the open position so that a front roller of the container can be received by the hook member as the container is pulled forward by the cable hoist mechanism. As the top frame is lowered into the horizontal home position, the gate member engages a subframe or other substructure on the vehicle and is pushed upward into the closed position to secure the container. The lockdown mechanism may include teeth depending downwardly from the hook member for meshing with upwardly projecting teeth on the subframe when the top frame is pivoted into the horizontal home position. The meshing teeth prevent the lockdown mechanism and container from shifting forward when the lockdown mechanism is spaced rearwardly from the forward limit stop. The gate member may include a support flange for supporting a front portion of the container when the top frame is in the horizontal home position.

The floating lockdown mechanism of the present invention may be used in a top frame having a front head portion that extends relative to a main portion of the top frame. The floating lockdown mechanism may also be incorporated into a fixed length top frame having no extendable head portion.

### BRIEF DESCRIPTION OF THE DRAWING VIEWS

The nature and mode of operation of the present invention will now be more fully described in the following detailed description of the invention taken with the accompanying drawing figures, in which:

FIG. 1 is a perspective view of a roll-off cable hoist apparatus having a floating lockdown mechanism in accordance with an embodiment of the present invention, wherein a cable of the hoist apparatus is not shown;

FIG. 2A is a plan view of a top frame of the cable hoist apparatus shown in FIG. 1, wherein a head portion of the top frame is in a retracted position and the cable is shown;

FIG. 2B is a view similar to that of FIG. 2A, wherein the head portion of the top frame is in an extended position;

FIG. 3 is a side view of the roll-off cable hoist apparatus wherein the top frame is tilted away from its horizontal home position, the head portion of the top frame is in an extended position, and a travel range of the floating lockdown mechanism is illustrated;

FIG. 4 is a schematic illustration of a sheave and cable arrangement of the cable hoist apparatus;

FIG. 5 is a perspective view showing the floating lockdown mechanism in a locked condition;

FIG. 6 is another perspective view of the floating lockdown mechanism in the locked condition, wherein the lockdown mechanism is shown in isolation;

FIG. 7A is a side elevational view showing the lockdown mechanism and a portion of a subframe of the cable hoist apparatus as the top frame of the cable hoist apparatus is pivoted downward toward its horizontal home position;

FIG. 7B is a view similar to that of FIG. 7A, showing the lockdown mechanism and the subframe portion after the top frame has reached its horizontal home position;

FIGS. 8A through 8F are a series of side elevational views illustrating a longer container being loaded onto a vehicle equipped with the cable hoist apparatus of the present invention; and

FIGS. 9A through 9F are a series of side elevational views illustrating a shorter container being loaded onto a vehicle equipped with the cable hoist apparatus of the present invention.

### DETAILED DESCRIPTION OF THE INVENTION

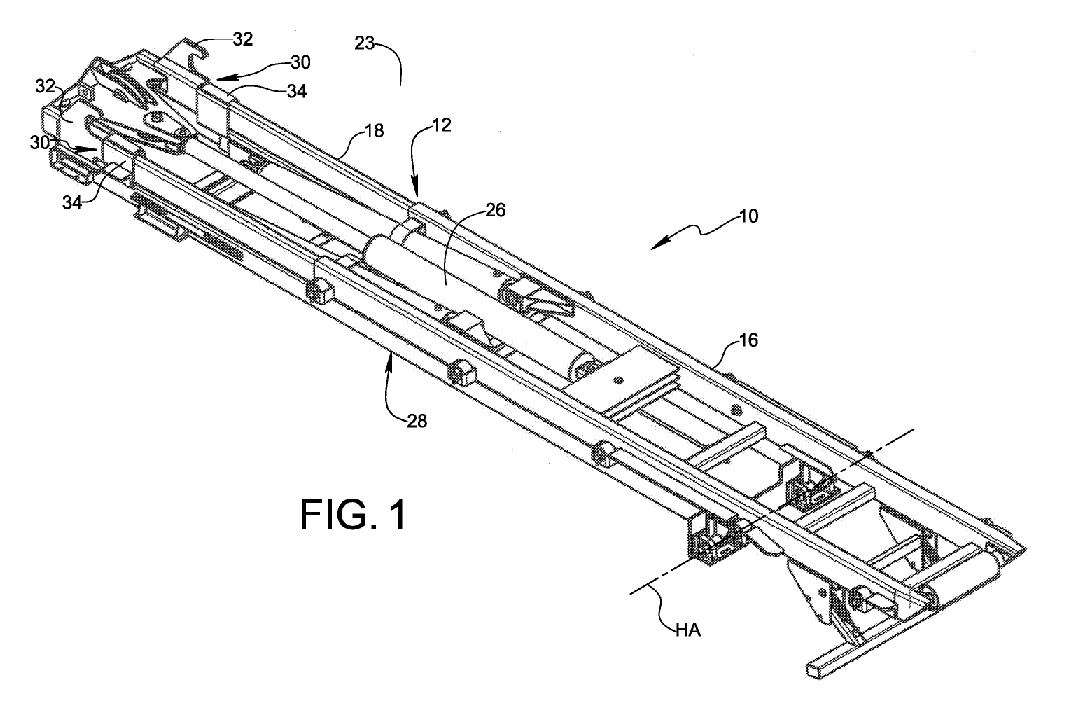

A roll-off apparatus 10 formed in accordance with an embodiment of the present invention is shown in FIGS. 1, 2A-2B, 3, 8A-8F, and 9A-9F. Apparatus 10 is mountable on a truck or similar vehicle, and includes a cable hoist mechanism connectable to a container. As will be apparent from the detailed description that follows, apparatus 10 is useful for loading and unloading containers of various lengths onto and off of a roll-off vehicle in a safe and efficient manner.

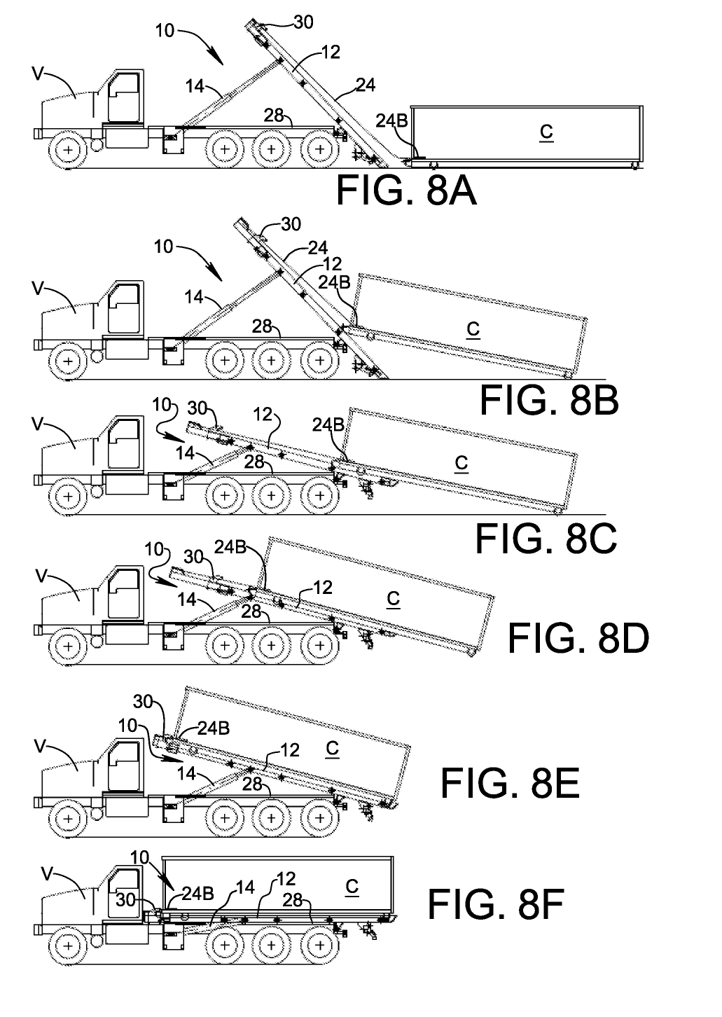

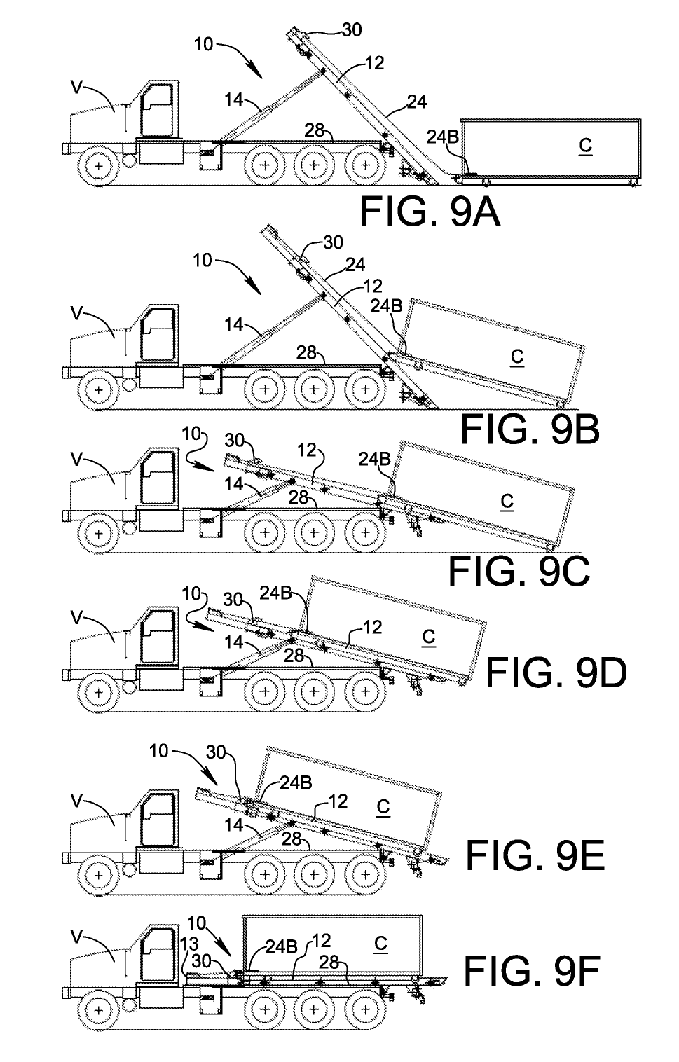

Apparatus 10 generally comprises a top frame 12 and a pair of laterally spaced lift actuators 14, only one of the lift actuators being visible in FIGS. 8A-8F and FIGS. 9A-9F. Top frame 12 is mounted on a vehicle V to pivot about a transverse hinge axis HA relative to the vehicle. As shown in FIGS. 8F and 9F, top frame 12 has a horizontal home position relative to vehicle V. Opposite ends of each lift actuator 14 are pivotally mounted to vehicle V and top frame 12, respectively. Lift actuators 14 are operable to rearwardly incline top frame 12 relative to vehicle V by pivoting the top frame about hinge axis HA away from the horizontal home position. For example, lift actuators 14 may be extended to tilt top frame 12 as shown in FIGS. 8A and 9A, and may be retracted such that top frame 12 assumes its horizontal home position as shown in FIGS. 8F and 9F. Lift actuators 14 may be hydraulic actuators. Alternatively, lift actuators 14 may be electromechanical actuators. While two laterally spaced lift actuators 14 may be used, it is conceivable to practice the invention using only one lift actuator which may be centrally located for balanced loading.

Top frame 12 includes a main portion 16 and a head portion 18 movably connected to main portion 16 for longitudinally directed displacement relative to the main portion. For example, main portion 16 and head portion 18 may be telescopically adjustable, wherein a pair of longitudinal side rails 18A, 18B of head portion 18 are slidably received within hollow longitudinal side rails 16A, 16B of main portion 16. Main portion 16 and head portion 18 may be steel weldments. In the depicted embodiment, side rails 16A, 16B include a plurality of support rollers 25 for supporting opposite sides of container C as the container is displaced along top frame 12.

Top frame 12 also includes a plurality of sheaves including a rear sheave 20 mounted to main portion 16 and a front sheave 23 mounted to head portion 18. As best seen in FIG. 4, the plurality of sheaves may further include a first intermediate sheave 21 mounted to head portion 18 and a second intermediate sheave 22 mounted to main portion 16. Rear sheave 20 and second intermediate sheave 22 may be coaxial as shown in FIG. 4.

A hoist cable 24 has a fixed end 24A coupled to head portion 18 and a free end 24B configured for coupling to a container C. Cable 24 extends from its fixed end 24A to its free end 24B by way of the plurality of sheaves. For example, in the illustrative arrangement depicted in FIG. 4, cable 24 extends from fixed end 24A to free end 24B by successive engagement with rear sheave 20, first intermediate sheave 21, second intermediate sheave 22, and front sheave 23.

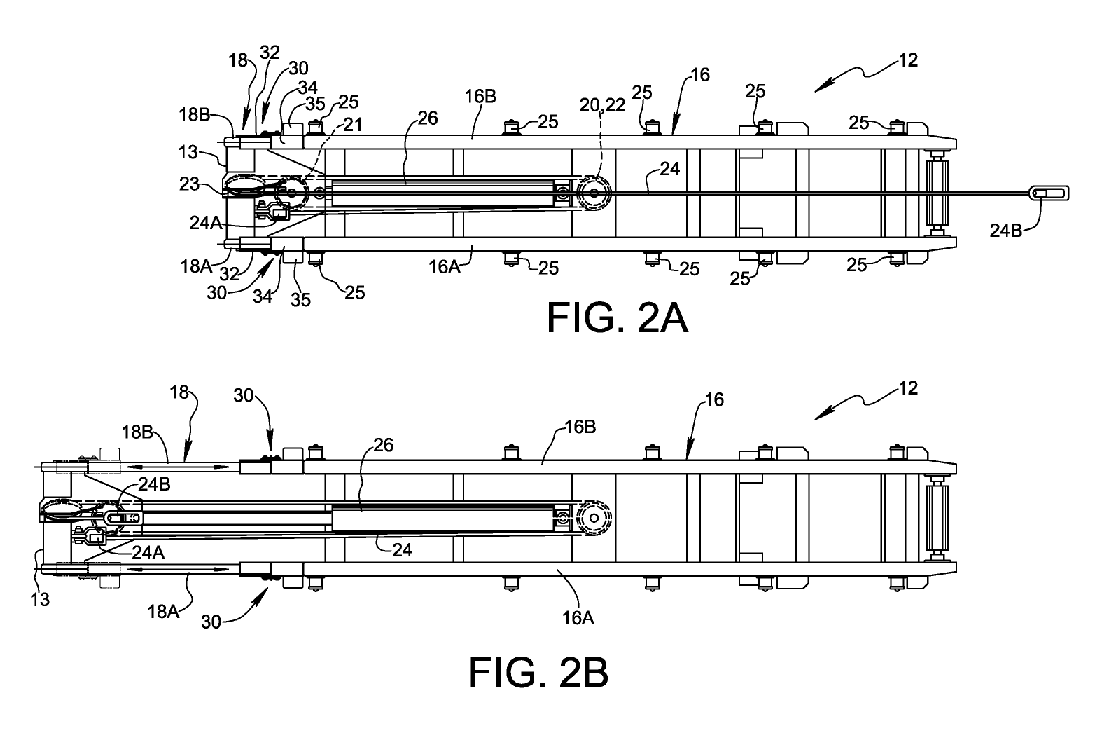

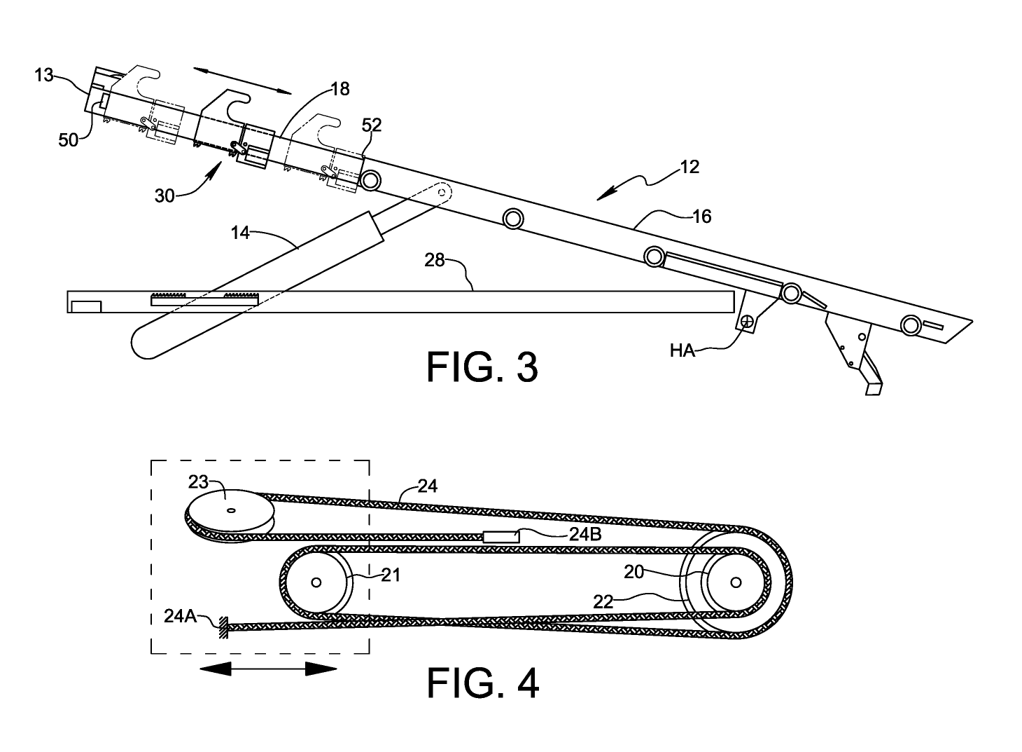

Top frame 12 further includes a hoist actuator 26 operable to longitudinally displace head portion 18 relative to main portion 16 between a retracted position shown in FIG. 2A and an extended position shown in FIGS. 2B and 3. Displacement of head portion 18 toward the extended position moves first intermediate sheave 21 and front sheave 23 away from rear sheave 20 and second intermediate sheave 22, thereby causing free end 24B of cable 24 to be pulled forward toward the front end of top frame 12. The diameters of the sheaves may be chosen to provide a mechanical advantage such that displacement of head portion 18 by hoist actuator 26 through a given distance results in an even greater displacement of cable end 24B toward the front end of top frame 12. For example, the sheaves may be sized and arranged to provide a 5:1 mechanical advantage, i.e. extending head portion 18 one foot draws cable end 24B five feet forward.

Apparatus 10 may further comprise a subframe 28 adapted to be fixedly attached to the vehicle V, and top frame 12 may be pivotally mounted on subframe 28 for pivoting motion about hinge axis HA. In this way, top frame 12 may be mounted on vehicle V by way of subframe 28.

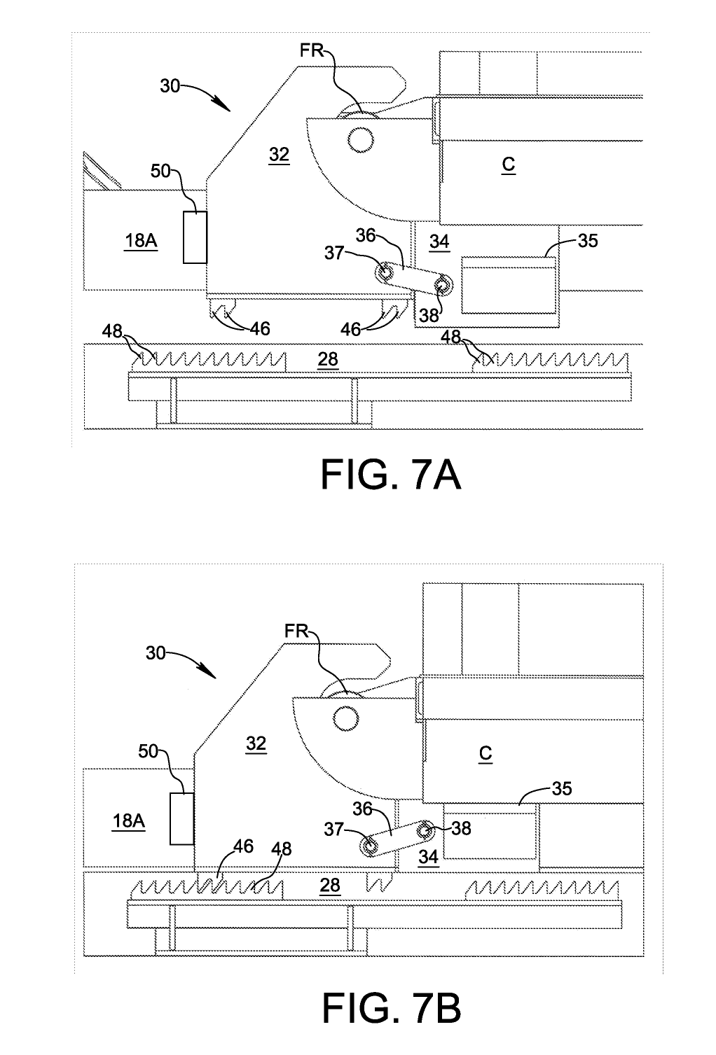

Apparatus 10 also comprises a lockdown mechanism 30 coupled to top frame 12 for releasably confining a front roller or a grab bar FR of container C as shown in FIG. 7B. Lockdown mechanism 30 is slidably movable relative to a front end 13 of top frame 12 along a longitudinal direction of the top frame. As best seen in FIG. 3, top frame 12 may include a forward limit stop 50 and a rearward limit stop 52, and lockdown mechanism 30 may be movable relative to front end 13 of top frame 12 between forward limit stop 50 and rearward limit stop 52.

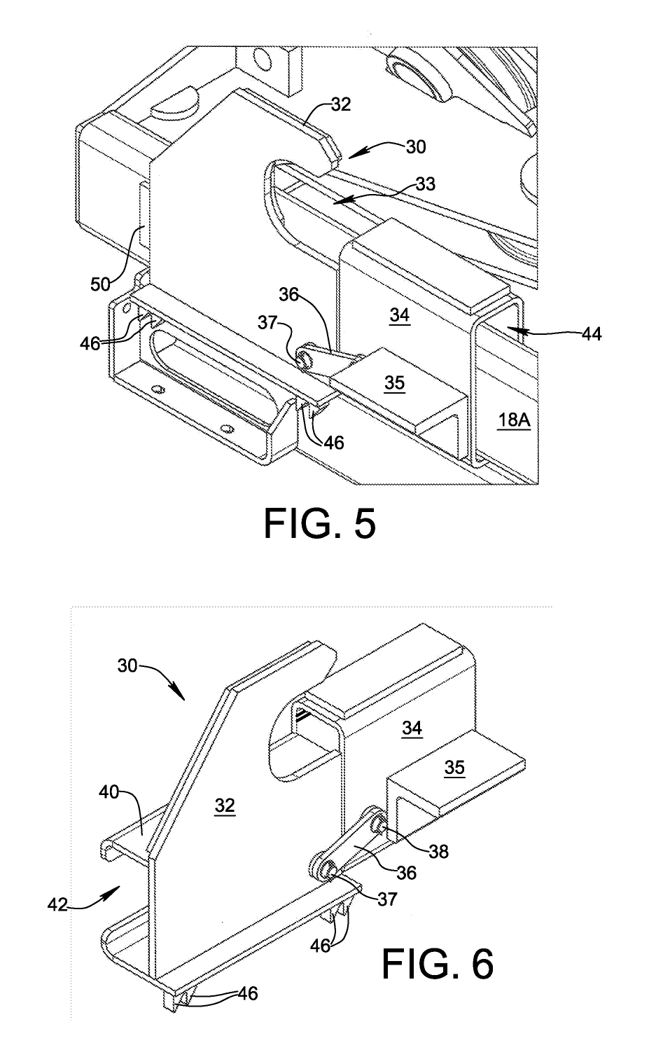

Lockdown mechanism 30 is shown in greater detail in FIGS. 5, 6, 7A, and 7B. In the depicted embodiment, lockdown mechanism 30 includes a front hook member 32 defining a rearwardly facing opening 33 for receiving front roller FR of container C, and a gate member 34 movably connected to hook member 32 and head portion 18. Lockdown mechanism 30 further includes a sleeve 40 fixed to an inner side of hook member 32. Sleeve 40 defines a longitudinal channel 42 sized for fitted mating with longitudinal side rail 18A of frame head portion 18. As shown in FIG. 5, longitudinal channel 42 slidably receives side rail 18A such that sleeve 40 and affixed hook member 32 have only one degree of freedom relative to side rail 18A, namely movement along a longitudinal axis side rail 18A. As will be understood by reference to FIGS. 1, 2A, and 2B, top frame 12 may include a pair of lockdown mechanisms 30 respectively associated with the pair of longitudinal frame members 18A, 18B on opposite sides of the top frame, wherein the pair of lockdown mechanisms 30 are mirror images of one another.

Gate member 34 is movable relative to hook member 32 and side rail 18A between an open position illustrated in FIG. 7A in which gate member 34 does not block hook opening 33, and a closed position illustrated in FIG. 7B in which gate member 34 at least partially blocks hook opening 33 to prevent withdrawal of front roller or grab bar FR. When top frame 12 is pivoted upward away from the horizontal home position as shown in FIG. 7A, gate member 34 drops down by gravity to the open position. When top frame 12 is pivoted into the horizontal home position as shown in FIG. 7B, subframe 28 engages gate member 34 to move gate member 34 to the closed position.

Gate member 34 may be a hollow tubular member defining a longitudinal passage 44 sized for vertical clearance mating with side rail 18A. Longitudinal passage 44 slidably receives side rail 18A such that gate member 34 has a first degree of freedom relative to side rail 18A allowing gate member 34 to move longitudinally along side rail 18A in unison with hook member 32. Passage 44 provides vertical clearance between gate member 34 and side rail 18A such that gate member 34 has a second degree of freedom relative to side rail 18A along an orthogonal axis of side 42 rail 18A perpendicular to the longitudinal axis of side rail 18A whereby gate member 34 can shift down and up relative to side rail 18A between its open and closed positions. Gate member 34 may be movably connected to hook member 32 by a link 36. Link 36 may be a rigid link pivotally mounted at a first location to hook member 32 by a pin 37 and pivotally mounted at a second location to gate member 34 by another pin 38, whereby gate member 34 is movable in a plane containing the longitudinal and orthogonal axes.

Gate member 34 may include a horizontal support flange 35 projecting laterally outward therefrom for supporting a side of container C near the front end of the container when top frame 12 is in its horizontal home position. Flange 35 is fixed to or integral with gate member 34 and therefore moves with lockdown mechanism 30 along side rail 18A. When gate member 34 is shifted to the closed position, a top surface of flange 35 engages with a bottom surface of a corresponding skid of container C such that a front portion of container C is supported by the flange. Flange 35 may be provided, for example, by welding or fastening a piece of angle iron on a side wall of gate member 34. As top frame 12 is tilted away from the horizontal home position, gates 34 and flanges 35 shift down by gravity to the open position, and weight of the container is substantially unloaded from head portion 18. When top frame 12 is rearwardly inclined, load associated with the weight of container C is borne by the stronger structural members of main portion 16, not by the structural members of head portion 18.

Forward limit stop 50 may be a stop member welded or otherwise fixed to longitudinal side rail 18A to block longitudinal travel of lockdown mechanism 30 in the forward direction, i.e. toward front end 13 of top frame 12. As lockdown mechanism 30 is moved forward, hook member 32 will come into abutment with forward limit stop 50 such that further forward travel is prevented. Similarly, rearward limit stop 52 may be a stop member welded or otherwise fixed to longitudinal side rail 18A to block longitudinal travel of lockdown mechanism 30 in the rearward direction, i.e. away from front end 13 of top frame 12. Alternatively, as shown in FIG. 3, rearward limit stop may be defined by a forward end of corresponding hollow longitudinal side rail 16A or 16B of main portion 16. As lockdown mechanism 30 moves rearward, gate member 34 will come into abutment with rearward limit stop 52 such that further rearward travel is prevented.

Lockdown mechanism 30 may include sloped teeth 46 depending downwardly from hook member 32 and arranged to mesh with sloped teeth 48 projecting upwardly from a flange associated with subframe 28 as top frame 12 is lowered down into its horizontal home position. Meshing teeth 46, 48 act to prevent unwanted forward sliding motion of lockdown mechanism 30 and container C when the lockdown mechanism is spaced rearwardly from forward limit stop 50 and top frame 12 is in its horizontal home position.

Operation of apparatus 10 to load a container C onto vehicle V will now be described with reference to FIGS. 8A-8F and FIGS. 9A-9F. In FIGS. 8A-8F, container C is relatively long, for example twenty-two feet in length. In FIGS. 9A-9F, container C is relatively short, for example sixteen feet in length.

As shown in FIG. 8A, vehicle V is parked with its rear end adjacent to a front end of container C, lift actuators 14 are extended to rearwardly incline top frame 12. At this stage, hoist actuator 26 and head portion 18 are fully retracted, and the free end 24B of cable 24 is coupled to a front coupling element provided on container C. Lockdown mechanism 30 slides by gravity into abutment with rearward limit stop 52 due to the incline of top frame 12.

In FIG. 8B, hoist actuator 26 begins to extend while top frame 12 is fully inclined, thereby pushing head portion 18 forward and drawing cable end 24B toward the front end 13 of top frame 12 to lift the front end of container C onto top frame 12. As may be seen, there is relative movement between lockdown mechanism 30 and the front end 13 of top frame 12 as head portion 18 begins to extend forward.

Next, in FIG. 8C, lift actuators 14 are retracted enough to lower top frame 12 to a shallower incline substantially even with an incline of container C. During this stage, hoist actuator 26 is kept at a constant length.

Continuing with FIG. 8D, hoist actuator 26 is extended further to continue extension of head portion 18, and to pull cable end 24B and container C further onto top frame 12. Meanwhile, lift actuators 14 are kept at a constant length.

In FIG. 8E, hoist actuator 26 and head portion 18 are fully extended to pull cable end 24B and container C all the way to the front end 13 of top frame 12. During this stage, lift actuators 14 are kept at a constant length. As may be seen, when the front roller FR of container C reaches lockdown mechanism 30, the front roller is confined is received through the hook opening 33 of lockdown mechanism 30 (see FIG. 7A), and thereafter lockdown mechanism 30 slides forward together with container C toward front end 13 of top frame 12 until lockdown mechanism 30 reaches forward limit stop 50 and/or hoist actuator 26 is fully extended.

Finally, as shown in FIG. 8F, lift actuators 14 are fully retracted to bring top frame 12 down to its horizontal home position for transport of container C. As explained above with reference to FIG. 7B, this step will cause gate member 34 of lockdown mechanism 30 to be moved into its closed position to confine front roller FR within hook member 32 of lockdown mechanism 30.

Reference is now made to FIGS. 9A-9F to describe operation of apparatus 10 to load a shorter container C onto vehicle V. The process is similar to that used to load a longer container. Because lockdown mechanism 30 “floats” (i.e. slides longitudinally) relative to front end 13 of top frame 12, the front end of shorter container C does not need to be pulled completely forward to the front end 13 of top frame 12 to meet with lockdown mechanism 30, as is required in prior art lockdown arrangements having a fixed lockdown mechanism at the front end of the frame.

As depicted in FIG. 9A, vehicle V is parked with its rear end adjacent to a front end of container C, lift actuators 14 are extended to rearwardly incline top frame 12. Hoist actuator 26 and head portion 18 are fully retracted, and the free end 24B of cable 24 is coupled to a front coupling element provided on container C. Lockdown mechanism 30 slides by gravity into abutment with rearward limit stop 52 due to the incline of top frame 12.

In FIG. 9B, hoist actuator 26 begins to extend while top frame 12 is fully inclined, pushing head portion 18 forward and drawing cable end 24B toward the front end 13 of top frame 12 such that the front end of container C is lifted onto top frame 12. Relative movement between lockdown mechanism 30 and the front end 13 of top frame 12 occurs as head portion 18 begins to extend forward.

Next, in FIG. 9C, lift actuators 14 are retracted enough to lower top frame 12 to a shallower incline substantially even with an incline of container C. Hoist actuator 26 is maintained at its current length.

Continuing with FIG. 9D, hoist actuator 26 is extended further to continue extension of head portion 18, thus pulling cable end 24B and container C further onto top frame 12. As may be seen, the shorter container C is almost completely on top frame 12. Meanwhile, lift actuators 14 are kept at a constant length.

In FIG. 9E, hoist actuator 26 and head portion 18 are extended further to pull cable end 24B and container C all the way onto top frame 12. During this stage, lift actuators 14 are kept at a constant length. As may be seen, when the front roller FR of container C reaches lockdown mechanism 30, the front roller is received through the hook opening 33 of lockdown mechanism 30 (see FIG. 7A). At this point, if cable end 24B is drawn further toward front end 13 of top frame 12, lockdown mechanism 30 slides forward together with container C. Extension of hoist actuator 26 and head portion 18 may be stopped when container C is at a position on top frame 12 that is spaced rearwardly from front end 13, thereby avoiding an undesirable loading condition if the center of gravity of container C is brought too far forward. Even though the front end of container C is set back from front end 13 of top frame 12, the front roller FR of container C is received in the floating lockdown mechanism 30.

Finally, in FIG. 9F, lift actuators 14 are fully retracted to bring top frame 12 down to its horizontal home position for transport of container C, thereby causing gate member 34 of lockdown mechanism 30 to be moved into its closed position to confine front roller FR within hook member 32 of lockdown mechanism 30.

Floating lockdown mechanism 30 is continuously adjustable relative to front end 13 of top frame 12 so that containers of any length within a range of container lengths can easily be accommodated and locked down in a desired and properly balanced longitudinal position along top frame 12. Adjustment of the longitudinal position of lockdown mechanism 30 occurs automatically as container C is loaded and pulled into position.

As may be understood, a reverse process may be followed for unloading container C off of vehicle V for any length container.

In the description above, top frame 12 has an extendable head portion 18. However, the floating lockdown mechanism 30 of the present invention may be incorporated into a top frame that has no extendable head portion (i.e. a fixed length top frame having longitudinal frame members). If a non-extendable top frame is used, there is no telescopic interface for defining rearward limit stop 52, and therefore rearward limit stop 52 may be embodied as a stop member welded or otherwise fixed to a longitudinal side rail on which lockdown mechanism is slidably mounted.

While the invention has been described in connection with exemplary embodiments, the detailed description is not intended to limit the scope of the invention to the particular forms set forth. The invention is intended to cover such alternatives, modifications and equivalents of the described embodiment as may be included within the scope of the invention.

What is claimed is:

1. An apparatus for loading and unloading containers of various lengths onto and off of a roll-off vehicle, the apparatus comprising:
a top frame mounted on the vehicle to pivot about a transverse hinge axis relative to the vehicle, the top frame having a horizontal home position relative to the vehicle;
at least one lift actuator operable to rearwardly incline the top frame relative to the vehicle by pivoting the top frame about the hinge axis away from the horizontal home position;
a cable hoist mechanism associated with the top frame, the cable hoist mechanism including a cable having a fixed end coupled to the top frame and a free end configured for coupling to the container; and
a lockdown mechanism coupled to the top frame for releasably confining a front roller or a grab bar of the container, wherein the lockdown mechanism is movable relative to a front end of the top frame along a longitudinal direction of the top frame.

2. The apparatus according to claim 1, wherein the top frame includes a forward limit stop and a rearward limit stop, and the lockdown mechanism is movable relative to the front end of the top frame between the forward limit stop and the rearward limit stop.

3. The apparatus according to claim 2, wherein the lockdown mechanism slides by gravity along the top frame toward the rearward limit stop as the top frame is pivoted away from the horizontal home position.

4. The apparatus according to claim 2, wherein the top frame includes a main portion and a head portion movably connected to the main portion for longitudinally directed displacement relative to the main portion, and wherein the cable hoist mechanism includes a hoist actuator operable to longitudinally displace the head portion relative to the main portion between a retracted position and an extended position, a plurality of sheaves including a rear sheave mounted to the main portion and a front sheave mounted to the head portion, the fixed end of the cable being coupled to the head portion and the cable extending from the fixed end to the free end by way of the plurality of sheaves, and wherein the lockdown mechanism is slidably mounted on the head portion for longitudinally directed displacement along the head portion.

5. The apparatus according to claim 4, wherein the head portion includes a longitudinal rail slidably received within a hollow longitudinal rail of the main portion, and the rearward limit stop is defined by a forward end of the hollow longitudinal rail of the main portion.

6. The apparatus according to claim 3, wherein the lockdown mechanism automatically locks when the top frame is pivoted to the horizontal home position, and the lockdown mechanism automatically unlocks by gravity as the top frame is pivoted away from the horizontal home position.

7. The apparatus according to claim 1, wherein the lockdown mechanism automatically locks when the top frame is pivoted to the horizontal home position, and the lockdown mechanism automatically unlocks by gravity as the top frame is pivoted away from the horizontal home position.

8. The apparatus according to claim 1, wherein the lockdown mechanism includes:
a front hook member defining a rearwardly facing opening for receiving the front roller of the container;
a sleeve fixed to the front hook member, the sleeve defining a longitudinal channel sized for fitted mating with a longitudinal member of the top frame, wherein the longitudinal channel slidably receives the longitudinal member of the top frame such that the sleeve has only one degree of freedom relative to the longitudinal member along a longitudinal axis of the longitudinal member; and
a gate member movably connected to the front hook member, the gate member being movable relative to the front hook member between an open position wherein the gate member does not block the opening of the front hook member and a closed position wherein the hook member at least partially blocks the opening of the front hook member.

9. The apparatus according to claim 8, wherein the gate member of the lockdown mechanism defines a longitudinal passage sized for clearance mating with the longitudinal member of the top frame, wherein the longitudinal passage slidably receives the longitudinal member of the top frame such that the gate member has a first degree of freedom relative to the longitudinal member along a longitudinal axis of the longitudinal member and a second degree of freedom relative to the longitudinal member along an orthogonal axis of the longitudinal member perpendicular to the longitudinal axis.

10. The apparatus according to claim 9, wherein the gate member has only the first and second degrees of freedom relative to the longitudinal member.

11. The apparatus according to claim 9, wherein the gate member is movably connected to the hook member by a link pivotally mounted at a first location to the hook member and pivotally mounted at a second location to the gate member, whereby the gate member is movable in a plane containing the longitudinal and orthogonal axes.

12. The apparatus according to claim 8, wherein the gate member includes a support flange for supporting a front portion of the container when the top frame is in the horizontal home position.

13. The apparatus according to claim 8, further comprising a subframe for mounting the top frame on the vehicle, the subframe including upwardly projecting teeth, wherein the lockdown mechanism includes teeth depending downwardly from the hook member, wherein the downwardly depending teeth are arranged to mesh with the upwardly projecting teeth when the top frame is pivoted into the horizontal home position.

14. The apparatus according to claim 8, wherein the top frame includes a pair of longitudinal frame members and the apparatus comprises a pair of the lockdown mechanisms respectively associated with the pair of longitudinal frame members.
